(19) United States
(12) Patent Application Publication
(10) Pub. No.: US 2025/0379878 A1
(43) Pub. Date: Dec. 11, 2025

(54) Anomaly Detection via a Detect and Collect Approach

(71) Applicant: Zscaler, Inc., San Jose, CA (US)

(72) Inventors: Sudipto Guha, Los Altos, CA (US); Praveen Tiwari, Milpitas, CA (US)

(73) Assignee: Zscaler, Inc., San Jose, CA (US)

(21) Appl. No.: 19/227,993

(22) Filed: Jun. 4, 2025

Related U.S. Application Data
(60) Provisional application No. 63/657,591, filed on Jun. 7, 2024.

(51) Int. Cl. H04L 9/40

(52) U.S. Cl. CPC H04L 63/1425; H04L 63/1441

(57) ABSTRACT

Systems and methods are disclosed for anomaly detection using a “detect and collect” cybersecurity monitoring approach. Initially, a cybersecurity monitoring system obtains and analyzes a baseline subset of telemetry data from computing resources to detect potential anomalies indicative of cybersecurity threats. Responsive to identifying such anomalies, the system selectively determines additional, contextually relevant telemetry data for targeted collection. This selective data collection significantly reduces telemetry volumes, enhancing efficiency and scalability. An intelligent data fabric and dynamic security knowledge graph are employed to enrich telemetry data in real-time, enabling comprehensive anomaly characterization, risk scoring, and automated security responses. The disclosed techniques support multimodal and multiresolution anomaly detection, adaptive learning, and rapid threat response within diverse distributed computing environments.

### CROSS-REFERENCE TO RELATED APPLICATION(S)

The present disclosure claims priority to U.S. Provisional Patent Application No. 63/657,591, filed Jun. 7, 2024, the contents of which are incorporated by reference in their entirety.

### FIELD OF THE DISCLOSURE

The present disclosure relates generally to networking and computing. More particularly, the present disclosure relates to systems and methods for anomaly detection via a detect and collect approach.

### BACKGROUND OF THE DISCLOSURE

Anomaly detection is a process in data analysis aimed at identifying patterns, data points, or events that deviate significantly from the norm or expected behavior. This technique is crucial in various fields, including fraud detection, network security, and predictive maintenance. By leveraging statistical methods, machine learning algorithms, or a combination of both, anomaly detection systems can efficiently distinguish between normal and abnormal data. Effective anomaly detection not only helps in pinpointing potential issues or irregularities but also in mitigating risks, enhancing security measures, and improving overall operational efficiency. Monitoring for anomaly detection involves several challenges, notably in determining the right amount of data to collect. Collecting excessive data can strain storage and processing resources, while insufficient data may lead to inaccurate detection. Ensuring data relevance and quality is crucial to avoid false positives or negatives. Establishing accurate baselines is difficult, especially in dynamic environments, and real-time processing demands robust algorithms. Adaptive learning is necessary but complex, and balancing sensitivity to avoid false alarms without missing true anomalies is critical. Privacy and security concerns also arise with extensive data collection, requiring compliance with regulations. Integrating anomaly detection systems with existing infrastructure adds another layer of complexity.

### BRIEF SUMMARY OF THE DISCLOSURE

The present disclosure relates to systems and methods for cybersecurity anomaly detection using a novel “detect and collect” approach. Unlike conventional methods that collect extensive telemetry data prior to anomaly analysis, the disclosed approach initially analyzes a carefully selected baseline subset of telemetry data to rapidly detect anomalies indicative of potential cybersecurity threats. Upon detecting such anomalies, the method selectively triggers collection of additional telemetry data specifically targeted to further characterize the identified anomalies. This selective and context-aware telemetry collection substantially reduces the volume of data requiring storage and analysis, thereby improving real-time responsiveness and resource efficiency.

The disclosed systems leverage advanced computational techniques, including vectorized telemetry representations, multimodal ensemble inference, and multiresolution Random Cut Forest (RCF) algorithms. These techniques enable the detection of anomalies at multiple scales of granularity, ranging from subtle behavioral deviations to overt security incidents. The method is integrated within an intelligent data fabric capable of real-time contextual enrichment and federated access to telemetry data across distributed environments. Furthermore, anomalies and related telemetry data are dynamically incorporated into a security knowledge graph, facilitating automated calculation of entity-specific risk scores and triggering appropriate security responses.

Through its detect-and-collect paradigm, adaptive anomaly detection models, and advanced analytics infrastructure, the disclosed approach provides robust, scalable, and efficient cybersecurity monitoring suitable for modern computing architectures, including cloud-based systems, edge environments, and large-scale enterprise deployments.

### BRIEF DESCRIPTION OF THE DRAWINGS

The present disclosure is illustrated and described with reference to the various drawings. Like reference numbers are used to denote like components/steps, as appropriate. Unless otherwise noted, components depicted in the drawings are not necessarily drawn to scale.

FIG. 1 illustrates a computing environment that includes a cloud-based system and a data fabric configured for cybersecurity monitoring.

FIG. 2 illustrates a flowchart of a method for cybersecurity anomaly detection using a detect-and-collect approach.

FIG. 3 is a block diagram of a computing system that may be used to implement various components described in this disclosure.

### DETAILED DESCRIPTION OF THE DISCLOSURE

The present disclosure relates to systems and methods for anomaly detection via a detect and collect approach in cybersecurity monitoring.

### Computing Environment

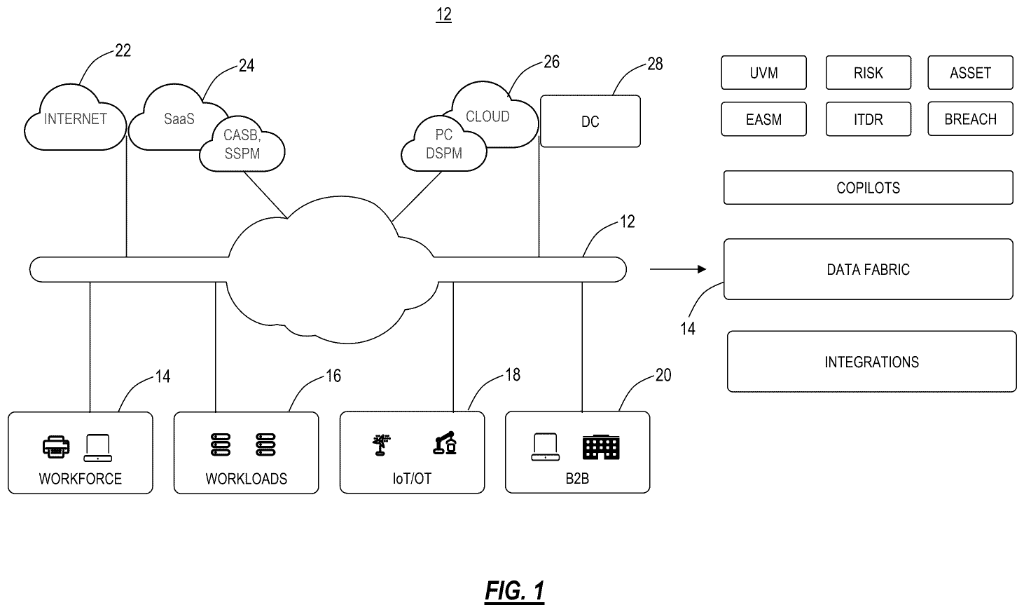

FIG. 1 illustrates a computing environment 10 that includes a cloud-based system 12 and a data fabric 14 configured for cybersecurity monitoring. The cloud-based system 12 can be implemented using the Zero Trust Exchange (ZTE) platform provided by Zscaler, Inc. The cloud-based system 12 offers cloud services designed to monitor, secure, and manage connectivity between various endpoints-including workforce devices 14, workloads 16, IoT (Internet of Things) and OT (Operational Technology) systems 18, and business-to-business (B2B) connections 20—and resources such as the Internet 22, SaaS applications 24, cloud services 26, and data centers 28. Unlike traditional network models that rely on implicit trust within a defined perimeter, the cloud-based system 12 utilizes a zero-trust architecture requiring continuous identity verification and strict adherence to security policies for each connection.

Endpoints route their traffic through the cloud-based system 12, which authenticates, inspects, and authorizes each request before allowing access to a target resource. For instance, when an employee attempts to access a SaaS application 24, the cloud-based system 12 intercepts the request, verifies the user's identity and device security posture, and enforces policies based on user roles, device security status, and location. Traffic is securely routed using encrypted tunnels, isolating endpoints from direct Internet exposure and preventing any direct access to applications or data until identity and compliance checks are successfully completed. This approach significantly reduces the threat exposure by ensuring that only validated traffic reaches the intended resources.

Beyond secure connectivity, the cloud-based system 12 can provide multiple cybersecurity functions, including threat inspection, data loss prevention (DLP), and comprehensive access control policies. Threat inspection involves scanning traffic for malicious content such as malware and phishing attacks using advanced techniques like sandboxing and behavioral analysis. DLP policies scrutinize outgoing data to prevent unauthorized data sharing, safeguarding sensitive information against unauthorized exposure or exfiltration.

For SaaS applications 24, the cloud-based system 12 integrates a cloud access security broker (CASB), which delivers granular visibility and control over user actions within SaaS environments. CASB facilitates context-based policy enforcement, data movement monitoring, and compliance management, thereby protecting SaaS platforms from data leaks and unauthorized access. Additionally, the cloud-based system 12 incorporates SaaS posture control to continuously evaluate application configurations and highlight security gaps or misconfigurations, ensuring consistent compliance with organizational security standards.

In the context of cloud services 26, the cloud-based system 12 integrates data security posture management (DSPM), which continuously monitors and protects data across public cloud environments. DSPM identifies sensitive data, enforces strict access policies, and detects misconfigurations or unauthorized access attempts, ensuring that data remains secure according to established governance requirements. Together, these integrated, cloud-native security capabilities enable secure, policy-driven access and robust, adaptive protection across distributed environments.

The cloud-based system 12 applies various policy actions designed to maintain secure and compliant connectivity between endpoints and resources. These policies control access, regulate data movement, and mitigate threats based on real-time analyses of network traffic, user behavior, and device posture. The following sections describe typical policy actions, along with examples of logged data generated by the platform to maintain detailed records of activities and security enforcement:
(1) Access Control Policies: These policies govern access permissions based on user roles, device type, location, and security posture. For example, an employee accessing sensitive financial applications from corporate-managed devices might be permitted, whereas requests from personal or untrusted devices are denied. Policies can also restrict access based on geographic location or specific timeframes, preventing unauthorized access during off-hours or from high-risk regions.
(2) DLP Policies: These policies monitor outgoing traffic to block unauthorized transfer of sensitive data, such as personally identifiable information (PII) or financial records. For instance, employees may be prevented from uploading documents containing PII to unauthorized cloud storage services or sharing confidential documents via external email, thus ensuring sensitive data remains within secure, approved channels.
(3) Threat Protection Policies: These policies proactively scan network traffic for malicious content, including malware and phishing attempts. For example, the cloud-based system 12 might block the download of suspicious files from the Internet, quarantining them for further analysis. Additionally, the platform conducts Secure Sockets Layer (SSL)/Transport Layer Security (TLS) inspections of encrypted traffic to uncover hidden threats and block connections to high-risk websites, thereby preventing malicious content from reaching endpoints.
(4) Application-Specific Controls: These controls enable precise governance of application features, such as disabling high-risk functionalities or restricting certain applications to read-only access for unauthorized users. For instance, administrative functions within critical SaaS applications may be limited exclusively to authorized personnel, whereas other users may have restricted, view-only permissions.
(5) Conditional Access Policies: These policies dynamically manage access based on criteria such as device compliance status or recent security incidents. For example, a device identified as non-compliant (e.g., missing security patches) may have its access to critical resources blocked until corrective measures are implemented.

The cloud-based system 12 generates comprehensive logs for audit, compliance, and threat analysis. The logged data typically includes:
(1) User and Device Information: Logs include details about users (e.g., usernames, roles, departments) and devices (e.g., device type, operating system version, compliance status), facilitating effective monitoring and auditing of resource access attempts.
(2) Time and Location Information: Each event is timestamped, with details regarding originating locations or IP addresses. Such data helps in identifying anomalous access patterns, like logins from unusual locations or outside standard hours.
(3) Application and Resource Access Data: Logs document the accessed applications or resources, specifying actions performed within each application, such as viewing, editing, or downloading, thereby providing clear audit trails.
(4) Threat Detection and Inspection Outcomes: When threats are identified, logs detail threat types (e.g., malware, phishing), detection methods (e.g., signature-based analysis, sandboxing), and the corresponding actions (e.g., blocking, quarantining), facilitating post-event analysis and attack pattern recognition.
(5) Policy Enforcement Results: Logs clearly indicate outcomes of policy enforcement actions-whether access was permitted, blocked, or redirected-and note instances of blocked data transfers (e.g., blocked PII or financial data), identifying potential attempts at data exfiltration.
(6) Compliance and Posture Verification: Logs capture compliance check results, detailing whether endpoints meet security requirements (e.g., latest OS updates, active antivirus protection), thereby providing insights into the effectiveness of security posture controls across endpoints.

Through comprehensive log data, the cloud-based system 12 ensures complete visibility into policy enforcement activities, user behaviors, and access patterns, enabling proactive risk management and continuous security monitoring across the organization.

### Cybersecurity Monitoring Systems

The endpoints-including workforce devices 14, workloads 16, IoT and OT devices 18, and B2B connections 20—are typically associated with a tenant, enterprise, corporation, or other organization. Monitoring these endpoints, as well as communications over the Internet and resources hosted in SaaS applications 24, cloud services 26, and data centers 28, is essential for cybersecurity purposes. Such monitoring generates associated log data relevant to security analysis and enforcement. While the cloud-based system 12 provides one example of a cybersecurity monitoring platform, the present disclosure is not limited to this implementation. Rather, it encompasses any cybersecurity monitoring approach, including standalone monitoring platforms, agents, software solutions, scanners, appliances, or other implementations.

Log data and telemetry data are two primary forms of observability data used in cybersecurity monitoring. Log data refers to event-based records that capture discrete actions or occurrences within a system, such as login attempts, file access events, firewall alerts, or system errors. These are typically generated by software components or infrastructure elements and are often unstructured or semi-structured. In contrast, telemetry data includes continuous or periodic streams of system metrics-such as CPU utilization, memory consumption, network latency, or API performance-collected in real time to track the operational state of systems or applications. While log data is often used for forensic analysis and policy enforcement, telemetry is more suited to performance monitoring and anomaly detection. Together, they provide complementary insights into system behavior and security posture.

As used herein, the term “cybersecurity monitoring system” broadly refers to any system, platform, service, application, local agent, or tool-whether cloud-based or on-premises-used to monitor activity within the computing environment 10. This includes monitoring of any resource or component in the environment for cybersecurity purposes. The term “system” is intended to encompass both hardware- and software-based implementations. Cybersecurity monitoring may target various threat categories, including malware, exposures, vulnerabilities, misconfigurations, posture violations, and policy non-compliance. In some embodiments, multiple cybersecurity monitoring systems may be employed, each configured to detect and respond to different types of threats, thereby enhancing overall security coverage.

Cybersecurity monitoring systems include a wide range of tools and technologies designed to protect an organization's infrastructure by continuously detecting, analyzing, and responding to threats across heterogeneous environments. For example, intrusion detection and prevention systems (IDS/IPS) identify and block suspicious traffic; security information and event management (SIEM) platforms aggregate data from diverse sources to detect complex threat patterns; and endpoint detection and response (EDR) tools monitor endpoint activity and support rapid containment of threats. External attack surface management (EASM) solutions provide visibility into publicly exposed assets and identify exploitable vulnerabilities. Network traffic analysis (NTA) tools monitor for anomalous traffic patterns, while vulnerability management systems assess systems for known security weaknesses.

In cloud environments, cloud-native monitoring platforms ensure configuration compliance and detect cloud-specific threats. Threat intelligence platforms (TIP) offer contextual data about emerging risks, while user and entity behavior analytics (UEBA) solutions detect insider threats through statistical and behavioral analysis. Application security monitoring tools focus on identifying vulnerabilities in software applications and APIs.

Collectively, these tools form a multi-layered defense strategy that improves an organization's ability to detect, contain, and respond to diverse cybersecurity threats. The present disclosure contemplates that the term “cybersecurity monitoring system” includes any of the foregoing tools or other systems designed for cybersecurity monitoring within the computing environment 10.

Data Fabric integration with Cybersecurity Monitoring

The data fabric 14 is a unified, intelligent data architecture that enables seamless integration, management, and access to data across cybersecurity monitoring systems spanning on-premises infrastructure, cloud platforms, and edge devices. In the context of cybersecurity, the data fabric 14 serves as an abstraction layer that interconnects disparate data sources, standardizes log formats and data models, for both log data and telemetry data, and supports real-time analytics-even when underlying systems are heterogeneous and distributed.

Cybersecurity monitoring systems-including SIEM platforms, EDR tools, CASBs, firewalls, vulnerability scanners, and cloud monitoring services-generate high volumes of structured and unstructured log data. These logs vary in syntax, semantics, and granularity depending on the source. The data fabric 14 integrates this data through a combination of the following mechanisms:
(1) Ingestion and Normalization: The data fabric ingests logs from multiple cybersecurity tools using APIs, syslog, Kafka streams, or custom connectors. It then normalizes this data into a unified schema or ontology (e.g., Elastic Common Schema (ECS), Open Cybersecurity Schema Framework), enabling consistent event correlation across tools.
(2) Metadata and Contextual Enrichment: The fabric enhances raw logs with contextual information-such as asset ownership, business unit, geolocation, and risk score—by referencing internal Configuration Management Databases (CMDBs) or external threat intelligence feeds. This enables complex queries like “show all high-risk access attempts to critical SaaS applications.”
(3) Federated Access and Virtualization: Rather than centralizing all data physically, the data fabric uses virtualization techniques to provide unified access to distributed data repositories. This minimizes latency and storage overhead while enabling real-time, global visibility.
(4) Correlation and Pattern Detection: The data fabric correlates events across sources to detect advanced threat sequences. For example, a phishing email identified by an email security system may be followed by lateral movement detected via EDR or NTA, allowing detection of multi-stage attacks.
(5) Policy Enforcement and Automation: By providing a holistic view of traffic and threats, the fabric supports centralized enforcement of global security policies. Integrated with Security Orchestration, Automation, and Response (SOAR) systems, it enables automated actions such as host isolation, access revocation, or alert generation based on policy violations or risk thresholds.
(6) Unified Observability and Dashboards: Security analysts can build dashboards, alerts, and reports using the fabric's abstraction layer, reducing tool sprawl and enabling centralized visibility into threat posture, control efficacy, and audit trails.

In an example embodiment, the data fabric 14 can integrate the following: SIEM alerts from platforms, Endpoint telemetry from EDR systems, Cloud activity logs SaaS usage data via CASB APIs, Network telemetry, and the like. Each source feeds logs into the data fabric 14, which deduplicates, timestamps, normalizes, and enriches the data. This unified layer enables cross-domain threat hunting, compliance auditing, and attack surface monitoring from a single pane of glass.

In essence, the data fabric 14 transforms fragmented, voluminous log data from disparate cybersecurity systems into an intelligent and actionable security data layer, empowering organizations to detect threats more effectively, ensure policy compliance, and automate incident response.

### Detect and Collect

The present disclosure introduces a cybersecurity monitoring technique referred to as “detect and collect,” which stands in contrast to the traditional “collect and detect” approach. In the conventional model, large volumes of telemetry data are continuously gathered from endpoints, networks, applications, and cloud environments. This data is then aggregated and analyzed-often retrospectively—to identify anomalies or threats. While this model provides broad coverage, it introduces several limitations, including high storage and processing requirements, delayed threat detection, and an unfavorable signal-to-noise ratio due to the reactive nature of the analysis. More specifically, the “collect and detect” approach suffers from the following challenges:
(1) Data Volume Overhead: Continuously collecting massive amounts of telemetry data imposes significant storage, bandwidth, and compute burdens. Managing and scaling infrastructure to handle these volumes can be costly and operationally complex. Conversely, limiting data collection risks omitting critical signals, undermining detection accuracy.
(2) Relevance and Data Quality: Not all telemetry data is equally valuable for detecting threats. Collecting irrelevant or low-quality data introduces noise, increases processing time, and may lead to inaccurate conclusions. High-quality, context-rich data is essential for reliable anomaly detection.
(3) Baseline Establishment: Anomaly detection depends on a well-defined model of “normal” behavior. Establishing and maintaining such a baseline can be difficult-especially in dynamic or heterogeneous environments where behavioral patterns evolve over time. An inaccurate or outdated baseline degrades detection effectiveness.
(4) Real-Time Detection Constraints: Many cybersecurity scenarios-such as network intrusion or fraud detection-require real-time or near-real-time analysis. Processing large, continuous data streams at high-speed demands highly optimized, scalable algorithms and infrastructure, which can be technically and financially prohibitive.
(5) Model Adaptability: Static anomaly detection models degrade over time as threat patterns and system behaviors shift. Effective systems must support adaptive learning and model evolution to maintain accuracy. However, implementing such adaptive models in production environments presents non-trivial design and validation challenges.
(6) False Positives and False Negatives: Striking the right balance between sensitivity and specificity is critical. Overly sensitive systems generate excessive false positives, leading to alert fatigue and reduced analyst confidence. Insufficient sensitivity risks missing genuine threats, potentially resulting in security breaches or operational disruptions.
(7) Privacy and Compliance Risks: Collecting extensive telemetry-particularly data that may contain personally identifiable information (PII) or sensitive business content-raises privacy concerns. Organizations must ensure that data collection complies with regulatory frameworks (e.g., GDPR, HIPAA) and that collected data is protected against unauthorized access or breaches.

In contrast, the “detect and collect” technique inverts this paradigm by applying lightweight detection logic at or near the data source-such as on endpoints, edge nodes, or inline sensors—to identify signals of interest in real time. Only the relevant or suspicious data associated with these early detections is then selectively collected, enriched, and forwarded for further analysis. This targeted approach dramatically reduces the volume of telemetry data that needs to be ingested and stored, while enabling faster detection and response.

Monitoring for anomaly detection under the detect-and-collect model presents unique challenges and trade-offs. One primary challenge is determining which detection signals are meaningful enough to trigger data collection without missing stealthy or low-signal threats. Balancing signal fidelity and data minimization is critical. Additionally, detection logic must be adaptive and context-aware to reduce false positives and avoid overloading downstream systems with unnecessary alerts.

This technique offers several advantages:
(1) Resource efficiency: Reduces the burden on centralized storage and compute by limiting data collection to high-value signals.
(2) Improved latency: Enables near real-time detection and triage at the edge or point of collection.
(3) Enhanced privacy: Minimizes unnecessary exposure of sensitive data by filtering what is collected.
(4) Operational scalability: Supports distributed and large-scale environments where collecting all telemetry is impractical.

The detect-and-collect model is particularly well suited for environments with constrained bandwidth or high data volume, such as edge computing, IoT/OT networks, and cloud-native architectures. When integrated into a broader security fabric or knowledge graph, this approach allows organizations to maintain situational awareness and threat visibility without being overwhelmed by telemetry volume.

Complexities of Anomaly Detection from both Theoretical and Practical Perspectives

The following presents a deep, multi-layered exploration of anomaly detection, drawing conceptual analogies between human cognition and machine intelligence, and advancing new models for scalable, real-time threat detection in cybersecurity. This description blends neuroscience, perceptual psychology, and modern machine learning into a cohesive framework for understanding and designing anomaly detection systems that are both robust and context-aware.

### Human Cognition as a Model for Detection

There are biological constraints of human perception-our sensory systems receive roughly 11 million bits per second, yet the cerebral cortex can consciously process only around 160 bits per second. This limitation is mitigated by the nervous system's exceptional ability to filter, encode, and prioritize information for survival, using attention as a key computational mechanism. This forms the philosophical and architectural basis for the anomaly detection approach described herein: instead of collecting and analyzing everything (the “collect and detect” model), systems should focus first on what looks anomalous and collect selectively-a model they term “detect and collect.”

### Detect and Collect: A Paradigm Shift

The detect-and-collect strategy flips traditional security telemetry models. Rather than indiscriminately aggregating all logs and telemetry data—an approach that is costly, inefficient, and slow—the system detects signals of interest at the edge (e.g., endpoint, workload, or service) and collects only the contextually relevant subsets of data needed for deeper analysis. This not only reduces noise and storage overhead but also enables real-time responsiveness and supports streaming-first anomaly detection architectures.

### Contextualization and Cognitive Metaphors

To support detect-and-collect, this disclosure provides a cognitive framework rooted in three layers of computational function:
(1) Representation and Contextualization: Inputs are encoded into vector representations, using techniques like RAG (Retrieval-Augmented Generation) and X2Vec. Context is captured via embeddings that combine local and global frames of reference, enabling the system to distinguish between what is normal in a localized vs. global sense.
(2) Retrieval and Remembrance: Inspired by episodic memory and neuromorphic encoding, this function involves storing significant “events” or anomalies as reference points. The system remembers not just data but the transitions or discontinuities-change is the signal.
(3) Reinforcement and Automation: Once anomalous behavior is identified and confirmed, it is reinforced through adaptive models or policy updates. This enables continuous learning while supporting automation through platforms like SOAR.
   Perception and Illusions: Lessons from the Mind

Drawing on visual illusions, such as the Ponzo and Ebbinghaus illusions, illustrate the importance of contextual baselines in detection. Just as our brains misinterpret visual cues due to contextual bias, anomaly detection systems must account for multiple frames of reference, or risk false positives/negatives. This is especially true in cybersecurity, where “normal” behavior is constantly shifting across users, devices, and networks.

By invoking the Two Streams Hypothesis (ventral “what” vs. dorsal “how” pathways in visual processing), this approach underscores the need for dual-model detection pipelines-slow, precise pattern recognition (ventral) and fast, reactive temporal pattern recognition (dorsal). Together, these support a hybrid inference model for dynamic environments.

### Multiresolution Density and Random Cut Forests

A key technical component is Random Cut Forests (RCF)-a lightweight, streaming-friendly anomaly detection algorithm that identifies externality-imposing points in a dataset. These are outliers that disproportionately affect cluster stability and density. RCF supports:
(1) Multiresolution encoding, where data is represented at different granularities to detect both micro and macro anomalies.
(2) Reversible and explainable outputs, critical for forensic traceability and root cause analysis.
(3) Adaptive learning, with the forest continuously updated using backing samples from a data stream.

By leveraging RCF within a detect-and-collect architecture, organizations can analyze vectorized representations in-flight without waiting for full log ingestion, supporting both high-performance and high-fidelity detection.

### Practical Applications in Cybersecurity

The present disclosure encompasses a variety of practical cybersecurity applications that leverage advanced anomaly detection techniques, particularly those based on vectorized representations and streaming analytics. Some example applications include:
(1) Traffic Analysis with Time-Series Vectorization (Shingling): Network traffic is transformed into time-series vectors using a shingling technique, where recent sequences of activity (e.g., packet size, protocol, destination IPs) are grouped into overlapping windows. This allows detection of anomalous flow patterns such as beaconing, exfiltration attempts, or command-and-control behavior by identifying deviations from established temporal norms.
(2) User and Entity Behavior Analytics (UEBA): By modeling user and system behavior as high-dimensional vectors, the system can detect subtle anomalies indicative of insider threats or compromised accounts. Behavioral baselines are established at the individual and group level, enabling the detection of outlier actions such as unusual access times, atypical resource usage, or lateral movement across systems.
(3) Breach Prediction via Knowledge Graph Correlation: Logs and telemetry data are ingested into a dynamic security knowledge graph that represents entities (e.g., users, devices, applications) and their relationships. Anomaly detection runs on this enriched graph structure, correlating weak signals across domains to identify potential breach paths—such as misconfigured access rights combined with abnormal data access patterns.
(4) Data Loss Prevention (DLP) Anomaly Reinforcement: Rather than relying solely on static content-based DLP rules, this approach reinforces DLP policies with anomaly detection techniques. For example, vector-based models can identify deviations in data access or transfer behavior that might precede or accompany data exfiltration attempts, even when the content does not match predefined sensitive patterns.
(5) Posture Monitoring via Vector-Based Misconfiguration Detection: System configurations and security postures (e.g., firewall rules, identity policies, cloud settings) are encoded as vectors and continuously monitored for shifts. Anomalies in these configuration vectors may indicate accidental misconfigurations or deliberate changes made by attackers to weaken defenses.

These use cases benefit from the core capability to represent security observations as contextualized vectors, enabling high-resolution behavioral analysis. This approach allows systems to track deviations with greater precision than traditional signature-or rule-based methods. Unlike legacy SIEM-based correlation engines that rely on post-ingestion analysis of large datasets, the proposed model supports localized detection at the edge, followed by global enrichment within the data fabric 14 or security knowledge graph.

This inversion-detecting anomalies early and then selectively collecting additional context-greatly reduces analytic bottlenecks and supports faster, more scalable detection workflows. By combining real-time detection with contextual graph-based correlation, the system achieves adaptive, high-fidelity monitoring across dynamic and distributed cybersecurity environments.

### Unified and Multimodal Inference

The present disclosure introduces a unified and multimodal inference framework for anomaly detection that combines multiple analytical techniques into an ensemble-based model. This approach integrates diverse inference strategies-including distance-based, density-based, neighborhood-based, predictive modeling, and domain-specific heuristics—to enhance detection accuracy and robustness across heterogeneous data sources and threat types.

Each inference modality contributes a complementary perspective:
(1) Distance-based methods identify anomalies as outliers in high-dimensional vector spaces, useful for detecting rare or extreme behavior.
(2) Density-based techniques assess local point density to surface anomalies that occur in low-density regions, capturing sparse or stealthy activities.
(3) Neighborhood-based approaches examine deviations from the behavior of nearby entities or peer groups, supporting contextual and group-based anomaly detection.
(4) Predictive models flag deviations from expected temporal patterns or sequences, enabling early identification of anomalous trends or events.
(5) Domain-specific heuristics encode expert rules and business logic tailored to specific environments (e.g., cloud, SaaS, OT), enhancing interpretability and operational relevance.

This multimodal ensemble ensures detection resiliency even in the face of adversarial tactics or noisy, incomplete data. The system can assign different weights or confidence scores to each inference mode based on context, thereby supporting dynamic fusion and prioritization of signals.

When integrated into the data fabric 14 or a security knowledge graph, this inference model unlocks several advanced capabilities:
(1) Graph-Based Risk Scoring: By analyzing entity relationships and anomaly signals across the graph structure, the system assigns dynamic risk scores to users, devices, applications, and other nodes. These scores evolve over time based on real-time events and inferred threat paths.
(2) Relationship Contextualization: The model enriches edges in the graph with contextual metadata-such as access method, policy violations, and behavioral changes-enabling detailed tracing of “who accessed what, how, and when.”
(3) Automated Workflow Triggering: Based on predefined thresholds, edge patterns, or graph topology changes (e.g., lateral movement, privilege escalation), the system can initiate automated security responses. For instance, detecting a multi-point failure across correlated nodes may trigger a workflow to isolate an affected device, revoke user access, or escalate the incident to human analysts.

By combining inferencing techniques and embedding them into a dynamic, graph-driven architecture, this unified framework supports adaptive, explainable, and high-fidelity anomaly detection across complex enterprise environments. It is particularly well suited for modern cybersecurity operations that demand both real-time responsiveness and contextual awareness across a wide range of telemetry, log, and behavioral data sources.

### Detect and Collect: Adaptive Telemetry in an Intelligent Data Fabric

Again, the present disclosure employs a “detect and collect” approach to anomaly detection, where an initial anomaly is detected based on a baseline subset of telemetry data, and that detection drives the selective collection of additional telemetry. This contrasts with the traditional “collect and detect” model, where extensive telemetry is collected continuously, and detection is performed retroactively by correlating and stitching together potentially relevant events.

In the detect-and-collect paradigm, detection is performed proactively on a reduced, high-value data subset, such as a vector representation of recent activity or baseline telemetry profiles. When an anomaly is identified within this baseline data-whether through vector deviation, outlier detection, or behavioral inconsistency—the system dynamically determines what additional context or telemetry is required to validate, explain, or respond to the anomaly. This approach minimizes unnecessary data collection, enabling real-time detection with targeted enrichment, significantly improving scalability and efficiency.

This methodology can be implemented as a method, apparatus, cloud service, and/or software application, operating within or alongside a data fabric architecture. The integration into a data fabric results in an intelligent data fabric 14-a system in which data is only collected on demand, based on detection signals, rather than through indiscriminate ingestion. This allows for precision telemetry and adaptive data flow that aligns with current system states and emerging threats.

The central objective is to ensure that the type of anomaly informs what telemetry is collected next. For instance, an access anomaly may trigger targeted collection of identity context, device posture, or geolocation data. By aligning telemetry collection with detected anomalies, the system can reduce data capture by orders of magnitude—from millions of telemetry signals down to thousands, or even hundreds, without compromising detection fidelity or response effectiveness.

### Data Fabric and Telemetry Context

The data fabric 14 is a unifying architectural approach that enables seamless, intelligent management of data across hybrid and distributed environments. It integrates structured and unstructured data from various sources-on-premises systems, cloud platforms, SaaS applications, and edge devices-into a cohesive framework for real-time access, sharing, and governance. Core capabilities of a data fabric include:
(1) Data virtualization, which enables querying across diverse sources without requiring physical data movement.
(2) Real-time processing to support time-sensitive decision-making and analytics.
(3) Automated data integration and transformation workflows.

When enhanced with AI and machine learning, the data fabric 14 becomes capable of intelligent operations such as automated data discovery, lineage tracking, policy enforcement, and anomaly-aware data routing. This infrastructure ensures consistency, quality, and security across the data landscape while reducing operational complexity. For cybersecurity, this fabric provides the foundation for scalable, adaptive monitoring across high-volume, distributed environments.

Within the data fabric 14, the collected information is referred to broadly as telemetry data. Telemetry in this context refers to the automated, real-time capture and transmission of metrics and signals from systems, devices, applications, and services. Examples include CPU utilization, memory consumption, packet loss, system errors, identity posture, and application performance metrics. Telemetry may also include logs, flow records, sensor outputs, or state change notifications.

Effective telemetry-driven anomaly detection enables systems to establish behavioral baselines and identify deviations in real time, such as sudden spikes in resource consumption, unauthorized access attempts, or configuration drift. Rather than indiscriminately collecting all telemetry, the detect-and-collect model leverages selective telemetry gathering based on observed anomalies, thereby improving performance, reducing costs, and enhancing responsiveness to dynamic conditions.

### Anomalies: Cross-Sector Use Cases

The techniques disclosed herein support a wide variety of anomaly detection use cases across industry domains, reinforcing both security and operational intelligence.

### Examples Include

Cybersecurity: Detecting anomalous network traffic, credential misuse, lateral movement, or behavioral outliers in cloud and SaaS environments. Real-time detection supports early threat containment and reduces breach dwell time.

Finance: Identifying fraudulent transactions or abnormal trading patterns, protecting financial assets and maintaining compliance with regulatory frameworks.

Manufacturing and IoT: Detecting anomalies in machine sensor data to anticipate equipment failure, enabling predictive maintenance and minimizing unplanned downtime.

Healthcare: Monitoring patient vitals or telemetry from medical devices to flag unusual patterns that may indicate critical health events or device malfunctions.

Retail and E-commerce: Identifying deviations in customer behavior, such as abnormal purchasing patterns or account activity, and optimizing inventory based on unexpected shifts in demand or supply chain irregularities.

These and other use cases highlight the versatility and impact of intelligent anomaly detection systems in enabling proactive risk mitigation, enhancing decision-making, and improving operational resilience across diverse sectors. Through its use of contextualized telemetry, intelligent data fabrics, and adaptive inference, the present disclosure supports scalable and efficient anomaly detection at both local and global levels.

### Scalable On-Device Anomaly Detection

The following disclosure outlines approaches for scalable anomaly detection, leveraging Random Cut Forest (RCF) algorithms both locally on endpoints and centrally on aggregated telemetry data. These approaches facilitate real-time anomaly detection, significantly reduce telemetry collection overhead, and enhance operational visibility in diverse computing environments.

### Local On-Device Anomaly Detection

Under this proposal, a Rust-based Random Cut Forest (RCF) model is deployed directly on endpoint devices via a lightweight local agent. The RCF algorithm analyzes a selected set of real-time input features that accurately reflect the endpoint's current state and behavior. Such input features may include:
(1) Network Traffic Metrics: Upload and download data volumes, Number of distinct domains visited within a specified recent time interval (e.g., last X minutes), etc.
(2) Device Performance Metrics: Wi-Fi signal strength and stability, Round-trip times (RTTs) for ping requests to designated endpoints, etc.
(3) Contextual Features: Geographic location of the device, Hour of day in local user time, etc.

When the local RCF model detects an anomaly indicative of abnormal or potentially malicious activity, the system proactively triggers automated packet capture (PCAP) operations. Captured packet data is securely stored locally on the endpoint device for subsequent detailed forensic analysis or remediation if required. This approach provides significant advantages including:
(1) Real-time anomaly detection at the device-level, allowing for rapid identification and mitigation of potential threats or operational issues.
(2) Minimal telemetry data transmission, reducing network bandwidth usage and centralized data storage requirements.
(3) Enhanced privacy and security through localized data storage, limiting sensitive data exposure.

### Centralized Anomaly Detection for Endpoint Telemetry

In this approach, each local endpoint agent periodically transmits encoded feature vectors representing the endpoint's current configuration and performance metrics to a centralized repository. At this central repository, an RCF model is applied on aggregated data from multiple endpoint agents using suitable encoding techniques, such as one-hot encoding. The RCF model identifies anomalous endpoint behaviors across various metrics, such as:
(1) Configuration Parameters: detecting unusual configurations or settings deviations indicative of misconfigurations or security policy violations.
(2) Performance Metrics: identifying endpoints exhibiting anomalous patterns in network latency, connectivity reliability, or Wi-Fi signal strength.

This centralized approach enables organizations to efficiently pinpoint devices experiencing anomalous behaviors, facilitating targeted troubleshooting and remediation. Practical applications include enhancing the accuracy of Wi-Fi signal diagnostics in user experience monitoring platforms, proactive identification of endpoint-level misconfigurations, and rapid detection of compromised devices. The anomaly detection principles mirror approaches successfully applied in fraud detection scenarios, where subtle deviations from typical behavior patterns are effectively highlighted.

### Post-Deployment Defect Detection in Serverless and IoT Environments

The third proposal extends the RCF-based anomaly detection techniques described above to identify operational defects and irregularities specifically in deployed serverless and IoT environments. For serverless applications, such as cloud-native microservices or IoT edge deployments, the endpoints effectively act as individual monitoring points (analogous to local agents), simplifying deployment. Each endpoint or serverless function continuously evaluates its operational metrics through an embedded RCF model, promptly detecting anomalies indicative of performance degradation, resource exhaustion, or unexpected behavior.

### Examples of Monitored Features in this Context Include

(1) Function invocation latencies and execution times.
(2) Frequency and patterns of function triggers.
(3) Resource usage metrics (e.g., memory utilization, CPU time).
(4) Error rates and types of exceptions.

When anomalies are detected, alerts can trigger automated corrective actions such as scaling operations, alerting DevOps personnel, or initiating rollback procedures. This approach facilitates proactive operational monitoring, rapid issue detection, and increased reliability and stability for serverless and IoT deployments. Collectively, these scalable RCF-based anomaly detection proposals provide robust, context-aware detection capabilities adaptable to diverse deployment models, improving cybersecurity, operational efficiency, and proactive monitoring across endpoints, user devices, and distributed serverless environments.

### Method

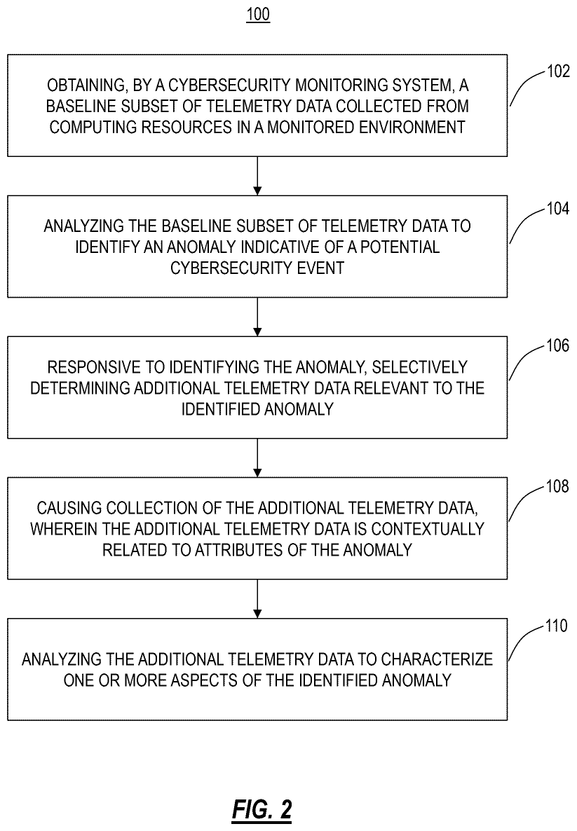

FIG. 2 illustrates a flowchart of a method 100 for cybersecurity anomaly detection using a detect-and-collect approach. The method 100 may be realized as a computer-implemented method including executable steps, carried out via an apparatus or computing device having one or more processors configured to perform the described steps. Additionally, the method 100 may be implemented within a computing environment or system configured specifically for executing these steps. Further, the method 100 may also be embodied as a non-transitory computer-readable medium storing executable instructions that, when executed by one or more processors, perform the described steps.

Specifically, the method 100 includes step 102, obtaining, by a cybersecurity monitoring system, a baseline subset of telemetry data collected from computing resources within a monitored environment. Telemetry data may include performance metrics, behavioral data, and other operational signals collected from computing endpoints, networks, and applications. The method 100 further includes step 104, analyzing the baseline subset of telemetry data to identify an anomaly indicative of a potential cybersecurity event. This step involves determining whether real-time telemetry deviates substantially from established normal behavior.

Responsive to identifying the anomaly, the method 100 continues with step 106, selectively determining additional telemetry data relevant to the detected anomaly. This selection is contextually guided by attributes of the detected anomaly, including anomaly type, severity, affected entities, or the magnitude of behavioral deviation. At step 108, the method 100 involves causing collection of the additional telemetry data. The additional telemetry data collected includes detailed metrics specifically related to the detected anomaly, such as device compliance status, user identity metadata, geolocation data, resource access logs, detailed network traffic metrics, or historical activity records. Subsequently, the method 100 includes step 110, analyzing the additional telemetry data to characterize and further understand one or more aspects of the detected anomaly. This characterization aids in determining appropriate remedial or investigative actions.

In some embodiments, obtaining the baseline subset of telemetry data at step 102 includes representing the telemetry data as contextualized vectors encoding metrics from multiple telemetry streams, thus enabling efficient anomaly detection through comparative analysis. Analyzing telemetry data at step 104 may include performing multiresolution anomaly detection at various granularity levels, thereby identifying both fine-grained and coarse-grained anomalies within telemetry vectors. In certain embodiments, multiresolution anomaly detection at step 104 is executed using a Random Cut Forest (RCF) algorithm. RCF is specifically utilized to detect anomalous data points by identifying externality-imposing points within telemetry vector spaces.

The method 100 may further employ a multimodal ensemble inference framework during the analysis at step 104. Such multimodal inference combines two or more anomaly detection methods selected from distance-based detection, density-based detection, neighborhood-based detection, predictive anomaly detection, and domain-specific heuristic detection. The method 100 may additionally include integrating anomaly detection and telemetry collection into an intelligent data fabric configured to selectively collect telemetry data at step 108 based on detection signals identified in step 104, thus enhancing operational scalability and real-time responsiveness.

In some embodiments, the method 100 further involves updating a dynamic security knowledge graph with detected anomalies and the selectively collected additional telemetry data. Updating the knowledge graph comprises enriching entity nodes and relationship edges with metadata, such as anomaly type, timestamp, severity level, affected entities, and associated threat intelligence indicators. Following enrichment, the knowledge graph at step 110 dynamically calculates risk scores for entities represented within the graph. These risk scores are derived from correlations among detected anomalies, historical behavior patterns, and other graph-enriched data.

The method 100 further includes automatically initiating predefined security responses based on dynamic risk scores exceeding certain predefined thresholds. Automated responses triggered by the knowledge graph may include actions such as isolating compromised devices, revoking user access privileges, initiating additional forensic data collection, or generating alerts for security analysts. In certain embodiments, the method 100 includes real-time enrichment of the selectively collected additional telemetry data at step 108 with contextual information prior to anomaly characterization at step 110. Such contextual information may include asset ownership metadata, business unit associations, geolocation context, or external threat intelligence indicators.

The method 100 achieves significant reductions in telemetry data volumes through the selective determination and collection approach described herein. Specifically, the selective telemetry collection can reduce data volumes by one or more orders of magnitude compared to conventional continuous telemetry collection approaches. The intelligent data fabric utilized by the method 100 may provide virtualized and federated access to telemetry data across distributed computing environments, allowing centralized real-time anomaly detection and subsequent data analysis.

Further, the intelligent data fabric can integrate telemetry data from diverse cybersecurity monitoring systems, including endpoint detection and response (EDR) systems, network traffic analysis (NTA) platforms, cloud monitoring tools, cloud access security brokers (CASBs), and security information and event management (SIEM) platforms, thereby providing comprehensive and correlated visibility into security events. Additionally, the method 100 includes continuously updating the Random Cut Forest algorithm at step 104 using telemetry data streams from the monitored environment, ensuring adaptive anomaly detection that evolves alongside behavioral baselines and environmental changes.

The method 100 further includes adaptively adjusting anomaly detection criteria and thresholds based on evolving behavioral baselines, environmental dynamics, and previous detection outcomes, thus maintaining effective anomaly detection performance over time. Overall, the method 100, through its detect-and-collect approach and integration with vectorized telemetry, multiresolution analysis, multimodal inference frameworks, intelligent data fabrics, dynamic security knowledge graphs, and automated workflow triggering, provides a robust, scalable, and context-aware cybersecurity anomaly detection capability suitable for modern complex computing environments.

### Example Computing System Architecture and Cloud Deployment

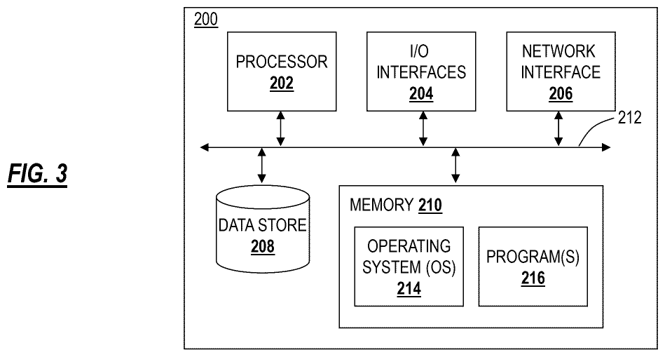

FIG. 3 is a block diagram of a computing system 200 that may be used to implement various components described in this disclosure. The computing system 200 can be implemented in many forms, including laptops, desktops, physical servers, clusters of machines, virtual machines (VMs) running on hypervisors, or serverless computing frameworks. Regardless of the underlying infrastructure, the computing system 200 typically includes one or more processors 202, input/output (I/O) interfaces 204, a network interface 206, a data store 208, and memory 210. Note that FIG. 3 provides a simplified representation; in practice, the computing system 200 may include additional hardware and software elements. These components 202, 204, 206, 208, 210 are connected via a local interface 212, which can include various wired or wireless buses, high-speed interconnects, or switching fabrics. The local interface 212 may also include controllers, buffers, caches, drivers, repeaters, and receivers, along with addressing and control lines that facilitate efficient communication and resource sharing among components.

Each processor 202 is a hardware element-such as a central processing unit (CPU), multicore processor, system-on-chip (SoC), graphics processing unit (GPU), or a processing element within a larger compute cluster-designed to execute software instructions. These processors may be general-purpose or specialized, depending on performance, power efficiency, or workload needs. During operation, each processor 202 retrieves and executes instructions stored in memory 210, manages data exchanges with the data store 208, and oversees system 200 operations. In large-scale environments, multiple processors 202 may operate in parallel to handle elevated traffic and complex workloads.

The I/O interfaces 204 enable the computing system 200 to interact with external peripherals, allowing user input (e.g., via keyboards, touchscreens, or sensors) and system output (e.g., to displays or printers). Depending on the application, these I/O interfaces 204 may also support specialized devices used for maintenance, debugging, or other administrative functions. Meanwhile, the network interface 206 handles connectivity to external networks, which may include the Internet, private networks, or cloud environments. This network interface can use Ethernet, wireless local area networks (LANs), cellular connections, or virtualized cloud interfaces. By using secure transport protocols and encryption, data transmitted via the network interface 206 can remain protected, enabling the computing system 200 to participate safely in distributed or cloud-based deployments.

The data store 208 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 208 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 208 can hold operational logs, configuration details, policy rules, program binaries, and cached computation results.

The memory 210 typically serves as the primary working memory for the processors 202. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 210 can be distributed across nodes or servers to support the large-scale in-memory processing demanded by modern cloud services. Generally, the memory 210 stores the operating system (O/S) 214 and one or more programs 216. The O/S 214 handles core system tasks such as process scheduling, memory allocation, file management, and networking.

For Software-as-a-Service (Saas) or other cloud-based components, the computing system 200 can be deployed in various ways: as a private cloud in a single organization's datacenter, a public cloud hosted by a third-party provider, or a hybrid cloud that combines both approaches for specific security, performance, or compliance considerations. Cloud computing abstracts physical hardware-servers, storage devices, and networks-into on-demand, scalable resources. This allows organizations to provision computing power, storage, and network bandwidth with minimal upfront costs, adjusting to fluctuating workloads seamlessly. According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing application hosting allows providers to uniformly release new features, apply security patches, and manage licensing. By using these SaaS models, end users can access software via browsers or lightweight clients, taking advantage of continuous improvements and frequent updates.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

### CONCLUSION

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps-even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement-whether collectively, separately, or in subsets-thereby broadening the range of potential embodiments.

What is claimed is:

1. A method for cybersecurity anomaly detection using a detect-and-collect approach, comprising:
obtaining, by a cybersecurity monitoring system, a baseline subset of telemetry data collected from computing resources in a monitored environment;
analyzing the baseline subset of telemetry data to identify an anomaly indicative of a potential cybersecurity event;
responsive to identifying the anomaly, selectively determining additional telemetry data relevant to the identified anomaly;
causing collection of the additional telemetry data, wherein the additional telemetry data is contextually related to attributes of the anomaly; and
analyzing the additional telemetry data to characterize one or more aspects of the identified anomaly.

2. The method of claim 1, wherein obtaining the baseline subset of telemetry data comprises encoding telemetry data as contextualized vectors.

3. The method of claim 2, wherein analyzing the baseline subset comprises comparing real-time telemetry vectors against baseline telemetry vectors representing normal operational states.

4. The method of claim 1, wherein selectively determining the additional telemetry data includes selecting telemetry data based on at least one of anomaly type, anomaly severity, affected entities, or degree of deviation from baseline metrics.

5. The method of claim 1, wherein the additional telemetry data comprises at least one of device compliance status, user identity metadata, geolocation data, resource access logs, detailed network traffic metrics, or historical user activity data.

6. The method of claim 1, further comprising updating a dynamic security knowledge graph with the identified anomaly and additional telemetry data.

7. The method of claim 6, wherein updating the dynamic security knowledge graph comprises enriching nodes and edges with contextually relevant metadata, including at least one of anomaly type, timestamp, severity, affected entities, or threat intelligence indicators.

8. The method of claim 7, further comprising dynamically calculating risk scores for entities represented within the security knowledge graph based on correlated anomaly data.

9. The method of claim 8, further comprising automatically initiating a security response if an entity's risk score exceeds a predetermined threshold.

10. The method of claim 9, wherein the security response comprises at least one of isolating a compromised device, revoking user access privileges, initiating forensic data collection, or alerting security personnel.

11. The method of claim 1, wherein analyzing the baseline subset of telemetry data to identify anomalies comprises applying a multimodal inference framework utilizing two or more anomaly detection methods including one of:
distance-based detection;
density-based detection;
neighborhood-based detection;
predictive anomaly detection; or
domain-specific heuristic detection.

12. The method of claim 1, wherein analyzing the baseline subset of telemetry data comprises employing a multiresolution anomaly detection algorithm to identify both fine-grained and coarse-grained anomalies.

13. The method of claim 12, wherein the multiresolution anomaly detection algorithm comprises a Random Cut Forest (RCF) algorithm.

14. The method of claim 13, further comprising continuously updating the Random Cut Forest using telemetry data streams from the monitored environment.

15. The method of claim 1, wherein selectively determining the additional telemetry data reduces the telemetry data collection volume by at least an order of magnitude compared to continuous telemetry data collection approaches.

16. The method of claim 1, further comprising enriching the additional telemetry data with contextual information selected from asset ownership metadata, business function associations, geolocation context, and relevant threat intelligence prior to analysis.

17. The method of claim 1, wherein the cybersecurity monitoring system utilizes an intelligent data fabric architecture configured to selectively collect and enrich telemetry data based on detected anomalies.

18. The method of claim 17, wherein the intelligent data fabric provides virtualized, federated access to telemetry data sources, enabling real-time anomaly detection and analysis across distributed environments.

19. The method of claim 17, wherein the intelligent data fabric integrates telemetry from two or more cybersecurity sources selected from endpoint detection and response (EDR) systems, network traffic analysis (NTA) systems, cloud monitoring tools, cloud access security brokers (CASB), and security information and event management (SIEM) platforms.

20. The method of claim 1, further comprising adaptively adjusting criteria for anomaly identification and subsequent telemetry collection based on evolving behavioral baselines and environmental changes detected in the monitored computing environment.
